(19) United States
(12) Patent Application Publication
(10) Pub. No.: US 2026/0065063 A1
(43) Pub. Date: Mar. 5, 2026

(54) DEEP KERNEL LEARNING FOR RISK MODELING WITH HIGH DIMENSIONAL MISSINGNESS

(71) Applicants: EQUIFAX INC., Atlanta, GA (US); THE UNIVERSITY OF NORTH CAROLINA AT CHAPEL HILL, Chapel Hill, NC (US)

(72) Inventors: Longxiu Tian, Chapel Hill, NC (US); Tian Zhao, Morrisville, NC (US); Stephen Miller, Leeds (GB)

(21) Appl. No.: 19/317,304

(22) Filed: Sep. 3, 2025

Related U.S. Application Data
(60) Provisional application No. 63/690,119, filed on Sep. 3, 2024.

(51) Int. Cl. G06N 3/088; G06N 3/047

(52) U.S. Cl. CPC G06N 3/088; G06N 3/047

(57) ABSTRACT

The present disclosure relates to methods and systems for training and utilizing a machine-learning model with a Deep Kernel Learning with Gaussian processes (DKL-GP) architecture to handle datasets with missing values. The system can receive a dataset with incomplete data, identify missing values, and process the dataset using the DKL-GP architecture. This can involve generating latent variables, utilizing inducing variables to approximate a Gaussian process, and mapping the latent variables to output predictions with associated uncertainty estimates. The system can optimize model parameters through a training process that leverages Pólya-Gamma data augmentation and Gaussian process inducing points for efficient computation. The trained model can subsequently be used to generate predictions for data records with missing data values, while obviating the need to impute potential values for the missing values, and make decisions based on the predictions.

### CROSS-REFERENCE TO RELATED APPLICATION

This claims priority to U.S. Provisional Application No. 63/690,119, entitled “DEEP KERNEL LEARNING FOR RISK MODELING WITH HIGH DIMENSIONAL MISSINGNESS,” filed on Sep. 3, 2024, the entire content of which is hereby incorporated by reference in its entirety.

### TECHNICAL FIELD

The present disclosure relates to the field of machine-learning and data processing such as techniques for training and utilizing machine-learning models using advanced techniques including neural networks, deep learning, Bayesian statistics, Deep Kernel Learning (DKL), or any combination thereof. More specifically, but not by way of limitation, this disclosure relates to the handling and inference of missing data entries to enhance the accuracy and reliability of predictive models across various applications.

### BACKGROUND

An assumption often made in data analysis is the completeness of the dataset such as that all pieces of information are available. However, in many applications, such as credit risk analysis, online shopping behavior, demographic studies, healthcare diagnostics, and environmental monitoring, datasets are frequently incomplete. Moreover, within a dataset, incomplete dimensions for one record, such as entity A did not provide demographics, may be different from another record such as entity B currently has no interaction history. Furthermore, making predictions based on new data points, which may lack certain dimensions, such as a missing address, an incomplete medical history, etc., can be challenging, especially when predictive techniques, such as machine-learning models, are based on incomplete data.

### SUMMARY

Aspects of the disclosed technology can include any combination of the features described herein. For example, a method can include receiving a dataset that can include a set of records in which at least one of the data dimensions indicates a missing value. The method can additionally include identifying the missing value within the dataset using a missing data indicator. The method can additionally include processing the dataset by applying a deep kernel learning with Gaussian processes (DKL-GP) framework. The method can additionally include inferring one or more data values for the missing value based on an output prediction generated by applying the DKL-GP framework to the dataset. The method can additionally include adjusting an objective function of a machine-learning model within the DKL-GP framework by optimizing model parameters in a training process to generate a trained machine-learning model. The method can additionally include saving the trained machine-learning model for subsequent use in making predictions.

In other examples, a method can include obtaining a data record that indicates a missing data dimension. The method can additionally include analyzing the data record using a trained machine-learning model. The model can be trained using a Deep Kernel Learning with Gaussian processes (DKL-GP) framework. The method can additionally include generating at least one output prediction based on analyzing the data record. The output prediction can include an uncertainty estimate. The method can additionally include making a decision based on the output prediction and the uncertainty estimate.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF THE DRAWINGS

FIG. 1 is a block diagram depicting an example of an operating environment in which a Deep Kernel Learning Gaussian Process (DKL-GP) related machine-learning model may be trained or utilized to predict outputs according to some aspects of the present disclosure.

FIG. 2 is a diagram depicting a Deep Kernel Learning Gaussian Process (DKL-GP) framework to train a machine-learning model according to some aspects of the present disclosure.

FIG. 3 is a flowchart illustrating an example of a method for training a machine-learning model using a Deep Kernel Learning Gaussian Process (DKL-GP) framework according to some aspects of the present disclosure.

FIG. 4 is a flowchart illustrating an example of a method for using a trained machine-learning model to predict an outcome according to some aspects of the present disclosure.

FIG. 5 is a table illustrating comparative advantages of training according to some aspects of the present disclosure.

FIG. 6 is a block diagram depicting an example of a computing device, which can be used to implement the embodiments described herein, according to some aspects of the present disclosure.

### DETAILED DESCRIPTION OF THE INVENTION

Certain aspects and examples of the present disclosure relate to techniques for enhancing the training and utilization of machine-learning models such as in contexts in which datasets are incomplete or contain missing data. In numerous fields, such as data forecasting, healthcare diagnostics, autonomous systems, environmental monitoring, and behavior analysis, the assumption of complete data is often unrealistic. Techniques herein can employ advanced operations, such as those involving Deep Kernel Learning (DKL), to address these challenges by enabling machine-learning models to generate output without inferring missing data points, such as by modeling a pattern associated with missingness of the missing data points, and to generate highly accurate and reliable predictions even in the presence of substantial data gaps.

One aspect of the disclosed technology is an ability to seamlessly integrate with existing machine-learning frameworks, which can allow for the enhancement of model performance without the need for extensive reengineering. The DKL-GP technique, in combination with Bayesian estimation, can model missingness and can map data into an embedding space that captures the intricate, non-linear relationships inherent in high-dimensional datasets. This process ensures that the machine-learning model can effectively leverage all available information, including the pattern of missing data dimensions, leading to superior predictive accuracy, while avoiding traditional imputation techniques in which a value is inferred when a data record's dimension is missing.

The disclosed technology further addresses the challenge of high-dimensional missingness in which the absence of data points can itself be informative. For instance, in risk analysis, the presence of missing data dimensions for an entity might indicate specific behaviors, and the disclosed technology can model these patterns such as to enhance predictive accuracy. This capability may be useful for domains in which understanding the implications of missing data can lead to better decision-making, as well as in domains where imputations are disallowed.

Furthermore, the disclosed technology may incorporate stochastic variational inference and Pólya-Gamma (PG) data augmentation during the training process. These techniques can enhance the efficiency of parameter optimization such as in scenarios involving large datasets with complex interdependencies among variables. The combination of these techniques also makes computationally infeasible training processes feasible and realistic, allowing for the development of advanced models that would otherwise be too resource-intensive to implement.

The disclosed techniques may be scalable, which can allow for the processing and analysis of massive datasets in real-time. This scalability can be used for applications in areas such as autonomous driving in which decisions may be made instantly based on incomplete sensor data, or in financial markets, where rapid responses to emerging trends can be the difference between profit and loss. The disclosed techniques can involve Gaussian processes, which can include a class of Bayesian nonparametric models with cubic computational complexity, which may be limited to ‘small data’ regimes. Where the efficiency gains from the DKL technique, combined with Pólya-Gamma data augmentation, ensure that the system can scale sub-cubically (per computing core) and parallelizable (across cores), making it suitable for real-time applications where both speed and accuracy are desired.

Another aspect can involve applicability across a wide range of domains. For instance, in healthcare, techniques can be used to train models that predict patient outcomes even when some clinical data is missing, which can improve the quality of diagnoses and care. In environmental monitoring, the system can enhance models that predict weather patterns or detect anomalies in ecosystems, even when sensor data is incomplete or delayed. The system may also support decision-making processes by providing accurate confidence intervals along with the predictions. By quantifying the uncertainty associated with the predictions, the system allows users to make more informed decisions, reducing the risk of errors and improving overall outcomes in critical applications such as predictive maintenance, malicious intent detection, and risk assessment.

The system may also improve the interpretability of machine-learning models. By utilizing Gaussian processes within the DKL framework, the system can provide insights into which features or inferred data points most significantly impact the model's predictions. This transparency can be valuable in examples in which understanding the rationale behind a model's decision may be as useful as the decision itself. Additionally, the system may be designed with case of integration. The system can be implemented within existing machine-learning pipelines with minimal disruption, which can provide an effective way to enhance model performance without the need for significant infrastructure changes.

As an example of a use case, in a financial institution, a predictive model is used to assess the creditworthiness of applicants. Traditionally, such models may rely on complete financial histories, which may not be available for all applicants, particularly those who are new to credit markets or who have experienced disruptions in their records. By implementing the system, the financial institution can train a machine-learning model that utilizes DKL-GP to infer how the particular pattern of missing data dimensions without explicitly imputing the missing dimension, which may be disallowed or computationally burdensome or impossible, such as due to unreported income or gaps in credit history, based on the available data. Once trained, the model can be used to assess new applicants, even if their data is incomplete. For example, if a new applicant lacks a full credit history, the model can learn a statistical embedding of an associated data dimension, such as a permutation of missing vs. non-missing dimensions, and generate a reliable risk assessment, complete with confidence intervals that indicate the level of uncertainty in the prediction. This enhanced model can allow the institution to extend credit to a broader range of applicants while maintaining a high level of confidence in its risk assessments.

The system can enhance the ability to generate previously missing data by integrating advanced machine-learning techniques, such as Deep Kernel Learning (DKL), into existing frameworks. By modeling missing data points, and inferring a pattern based on the missing data points, and by mapping the information into an embedding space, this approach may allow for a more accurate and comprehensive analysis. The importance of this analysis may extend beyond traditional uses, providing valuable insights into the conservativeness of current ‘thin file’ definitions. Specifically, the framework can evaluate the impact of initiating scoring one period, or multiple periods, earlier than the conventional threshold, potentially redefining the boundaries of risk assessment.

The system can allow for an understanding whether a particular categorization of a target entity is excessively cautious or if it reflects genuine modeling challenges due to limitations in machine-learning techniques and training techniques. The system can provide that the transition in risk assessment status is a gradual process rather than a marked ‘cliff’ at the point of transition. This gradual transition suggests that traditional categorizations may overlook significant behavior insights that could be captured with more advanced modeling techniques, such as those described herein.

The system allows, through extension of the application of DKL-GP models to include scenarios with high-dimensional missing data, outperformance of conventional models in certain hold-out samples but offers a more efficient and accurate understanding of risk assessment. The system can serve as both a technical enhancement to existing risk assessment systems and an analysis of algorithmic impacts on equality, particularly in promoting greater inclusivity while maintaining robust risk controls. The system can use Bayesian machine-learning in estimating models, particularly in addressing the challenges posed by missing data. Moreover, the results have broader implications for algorithmic fairness, as the ability to accurately assess individuals who were previously unscoreable promotes greater equity in providing services.

The system can allow for the creation of models which may allow for machine-learning models, including neural networks, to be trained with predictive capabilities even when the dataset on which the data is trained is incomplete such as in one or more data dimensions or data attributes. As the number of missing attributes grow, training a machine-learning model with sufficient predictive capabilities and accuracy becomes increasingly difficult or even impossible. Traditional training techniques are unable to be trained on such datasets with a high number of missing attributes. Additionally, the missing attributes further contribute to the computational complexity of training a machine-learning model on such datasets. Through the inclusion of data augmentation techniques, such as stochastic variational approaches such as PG data augmentation and inducing point GP, the training of the model may be accelerated to be realistically performed in linear time, near-linear time, or a combination thereof. The choice of inducing point Gaussian processes may also allow for a tradeoff between accuracy of the model and the computational speed or training speed of the machine-learning model. Additionally, the trained machine-learning models may allow for a prediction to be made on a data point which includes one or more missing attributes.

The system can allow for the transmission of risk indicators or risk related information to a remote computing system. The risk indicator or the risk related information may be related to the output of the trained machine-learning model. In some examples, this may be the system from which the risk indicator was requested. The risk indicator can be used to control access of the target entity to an interactive computing environment. For example, the risk indicator can be included in a responsive message to the request for evaluating the target entity such that the responsive message can be used to allow, challenge, or deny access to the target entity. For example, if the risk indicator can be below a predefined threshold, a request by the target entity to access the interactive computing environment may be automatically denied or flagged for manual review. The risk indicator may have multiple aspects or dimensions, which may allow for a granular control or access of one or more aspects of the interactive computing environment.

Certain aspects described herein, which can include generating, such as by using a machine-learning model trained using the techniques disclosed herein, one or more risk indicators associated with target entities and providing a responsive message using the risk indicator, can improve at least the technical fields of controlling interactions between computing environments, access control for a computing environment, or a combination thereof. For instance, by generating and transmitting the responsive message, the risk assessment computing system can cause access to a computing system to be controlled, such as allowed or prevented, more accurately. The risk indicator may be used to better predict whether the target entity requesting access is legitimate, and using the risk indicator may yield fewer malicious interactions than if the responsive message is not used. Further, the risk assessment computing system leverages distinctive components of the risk indicator to create a robust and easily implemented framework.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

### 1. Operating Environment Example for Training a Machine-Learning Model

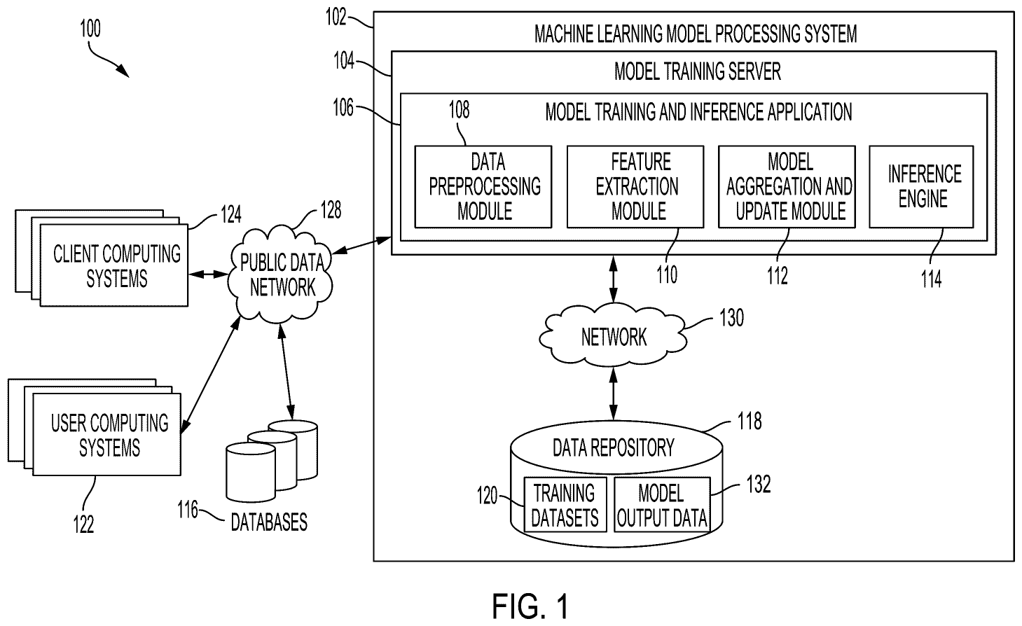

Referring now to the drawings, FIG. 1 is a block diagram depicting an example of an operating environment 100 in which a machine-learning (ML) model processing system 102 can be used to train and deploy a machine-learning model such as for handling missing data using a DKL-GP architecture. FIG. 1 depicts examples of hardware and software components of the ML model processing system 102, which may be a specialized or general-purpose computing system capable of processing large datasets and performing complex calculations. The ML model processing system 102 can include a model training server 104 for training the machine-learning model and deploying it for real-world applications such as generating predictions or making decisions.

The model training server 104 can include one or more processing devices that execute a model training and inference application 106, which includes various modules designed to handle the preprocessing, training, and inference tasks associated with the model. Some examples of the modules may include a data preprocessing module 108, a feature extraction module 110, a model aggregation and update module 112, and an inference engine 114.

The data preprocessing module 108 may be responsible for receiving raw input data, addressing missing values through imputation, transforming the data into a suitable format for further processing, or any combination thereof. Once preprocessed, the data may be passed to the feature extraction module 110 in which meaningful features can be extracted to facilitate efficient and effective model training. The model aggregation and update module 112 may aggregate updates to the model parameters during the training process, for example to ensure that the model evolves with each iteration. For example, during an interactive process, the model aggregation and update module 112 may update the hyperparameters of the machine-learning model being trained on a set of data.

The inference engine 114 may include one or more algorithms, trained machine-learning models, or a combination thereof. The inference engine 114 may generate predictions or classifications using the trained model. In some examples, the inference engine 114 may account for uncertainties in the data through techniques such as Gaussian processes. The inference engine 114 may include one or more of the trained machine-learning models that have been trained using the techniques described herein.

The model training server 104 can interact with a data repository 118 via a network 130. The data repository 118 can store one or more datasets, which can include training datasets 120 and model output data 132. The training datasets 120 may be used to train the machine-learning model. The training datasets may include incomplete, fragmented, or missing data attributes for data records within the dataset. The incomplete data makes it difficult for a traditional model to be trained effectively on this data. The model output data 132 may include the results generated by the trained model, such as predictions, confidence intervals, or inferred values, which may be stored for further analysis or use in decision-making processes.

In some aspects, the model training server 104 can perform additional tasks related to the validation and deployment of the machine-learning model, using the modules within the model training and inference application 106. The server may receive external datasets from databases 116 or data input systems 122, which can feed new data into the model for ongoing training or real-time inference. The databases 116 may store external data sources such as documents, records, or other relevant data that can be used to enhance the performance of the model. The data input systems 122 can represent external data feeds or sensors that provide real-time data such as for immediate processing. For example, the databases 116 or the data input systems 112 may include a new data point for which a prediction or other output is to be obtained based on the trained machine-learning model such as included within the inference engine 114. The new data record on which a prediction is to be made may be incomplete or missing several attributes. The model training server 104, or other component illustrated in FIG. 1, may allow for predictions to be made even if a data point is missing one or several data elements.

The data repository 118 or other network-attached storage units within the operating environment 100 may store a variety of different types of data organized in various ways and from multiple sources. The network-attached storage unit may include storage beyond the primary storage located within the model training server 104 that may be directly accessible by the processors therein. In some aspects, the network-attached storage unit may include secondary, tertiary, or auxiliary storage, such as large hard drives, servers, and virtual memory, among other types of suitable storage. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory devices, or other suitable media.

Furthermore, the ML model processing system 102 can communicate with various other computing systems. The other computing systems can include user computing systems 122, such as smartphones, personal computers, etc., client computing systems 124, other suitable computing systems, or any combination thereof. While FIG. 1 illustrates that the ML model processing system 102 and the client computing systems 124 are separate systems, the ML model processing system 102 and the client computing systems 124 can be one system. For example, the ML model processing system 102 can be a part of the client computing systems 124, or vice versa. The client computing systems 124 may deploy the model in a model deployment environment, such as an online platform or service where the model generates predictions based on new data or data stored in the databases 116

The ML model processing system 102 may communicate with various other computing systems via one or more data networks such as the public data network 128. The communications can involve transferring data for further processing, receiving updates to the model, delivering the model's outputs to end-users or other systems, or any combination thereof. The network may include a combination of wired and wireless connections, supporting a robust and scalable infrastructure for large-scale data processing and machine-learning tasks.

In some examples, the client computing systems 124 may include other computing resources associated therewith such as server computers hosting and managing virtual machine instances for providing cloud computing services, server computers hosting and managing online storage resources for users, server computers for providing database services, and others. The interaction between the user computing systems 122, the client computing systems 124, and the ML model processing system 102, or any suitable sub-combination thereof, may be performed through graphical user interfaces, such as the user interface, presented by the risk assessment computing system 102, the client computing systems 124, other suitable computing systems of the computing environment 100, or any suitable combination thereof. The graphical user interfaces can be presented to the user computing systems 122. Application programming interface (API) calls, web service calls, or other suitable techniques can be used to facilitate interaction between any suitable combination or sub-combination of the client computing systems 124, the user computing systems 122, and the risk assessment computing system 102.

A user computing system 122 can include any computing device or other communication device that can be operated by a user or entity, such as the user entity, which may include a consumer, a customer, or other using entity. The user computing system 122 can include one or more computing devices such as laptops, smartphones, and other personal computing devices. A user computing system 122 can include executable instructions stored in one or more non-transitory computer-readable media. The user computing system 122 can additionally include one or more processing devices configured to execute program code to perform various operations. In various examples, the user computing system 122 can allow a user to access certain online services or other suitable products, services, or computing resources from a target entity, such as the client computing system 124, to engage in mobile commerce with the client computing system 124, to obtain controlled access to electronic content, such as the interactive computing environment 126, hosted by the client computing system 124, etc.

In a simplified example, the system illustrated in FIG. 1 can configure the model training server 104 to be used for generating predictions based on information from the client computing systems 124, the user computing systems 122, or a combination thereof. The model training server 104 can retrieve data sources associated with one or more of the computing systems in response to a request to perform a prediction or to re-train a machine-learning model. The data sources may, for example, be retrieved from databases 116 or received via other suitable computing systems. The databases 116 can store, for example, data sources such as articles or other publications periodically scraped from the Internet. The model training server 104 can determine a risk indicator associated with the target entity by extracting and analyzing text from a data source to determine the target entity's involvement in certain events and sentiment scores associated with the events. The model training server 104 can transmit a data record, or any inference derived therefrom, to the client computing system 124 as an output prediction.

Each communication within the computing environment 100 may occur over one or more data networks, such as a public data network 128, a network 130, such as a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The number of devices illustrated in FIG. 1 is provided for illustrative purposes. Different numbers of devices may be used. For example, while certain devices or systems are shown as single devices in FIG. 1, multiple devices may instead be used to implement these devices or systems. Similarly, devices or systems that are shown as separate may be instead implemented in a signal device or system.

### II. Example Architecture for DKL-GP Model

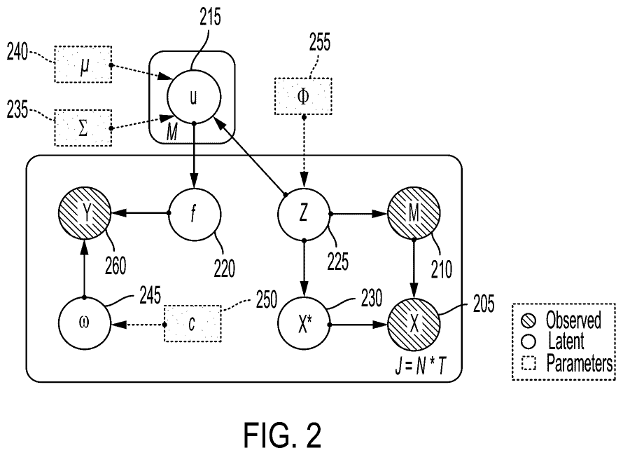

FIG. 2 is a diagram depicting a Deep Kernel Learning Gaussian Process (DKL-GP) framework to train a machine-learning model according to some aspects of the present disclosure. Illustrated in FIG. 2 is architecture 200. The architecture 200 may be a visual representation of how the DKL-GP model processes data such as in scenarios involving missing data or sparse data. The architecture 200 is illustrated as a graph that may be a mathematical structure that includes nodes and edges. The architecture 200 includes nodes 205-255, which are further described below. For clarity, the edges (or links) between the nodes are not labeled. The DKL-GP model can be trained via conventional Gaussian Process or Bayesian estimation strategies, which can result in an end-to-end inference framework that leverages the representational capabilities of neural networks while benefiting from GP's uncertainty quantification.

The DKL-GP model may use observed data record X along with corresponding missing data indicators M to infer a pattern based on theoretical true underlying data values X*. In some examples, the DKL-GP model may not directly infer what the actual values of X* are. The Gaussian process, summarized by the inducing variables u, can be used to model the uncertainty in the data and make predictions.

a. Overview of Directed Acyclic Graph (DAG)

A directed acyclic graph (DAG) is a graphical representation used to model the relationships between different components or variables in a system. In the context of a machine-learning model, such as the DKL-GP architecture, a DAG can visually depict how data flows through the model and how different variables are related to each other. GP may be nonparametric supervised learning methods used to solve regression and probabilistic classification problems. In a DAG, the connections between nodes (represented by arrows) may be directed, meaning they flow in one direction. This directionality indicates the flow of information or the dependency between variables. For instance, if there is an arrow from node A to node B, this implies that node B depends on node A, or that information flows from A to B.

The term acyclic means that the graph may not have any cycles. That is, there may be no loops in the graph such as in which the process may start at one node, follow the directed edges, and eventually return to the same node. In the context of a machine-learning model, this prevents feedback loops and ensures that the data flows in a linear and hierarchical manner through the model. Each node in the DAG may correspond to a specific variable or component in the model. For example, nodes might represent observed data (X), latent variables (Z), inducing variables (u), or missing data indicators (M). Each of these nodes holds a specific role in how the model processes data.

The directed edges between nodes may indicate the dependencies or flow of information. For instance, there may be an edge from the node representing observed data (X) to the node representing the latent variables (Z), indicating that the latent variables are inferred based on the observed data. Similarly, edges from the latent variables (Z) to the latent function (f) may indicate that the function is learned based on the latent variables.

b. Nodes and Their Roles

Node 205, representing the observed data (X), may encompass the raw input data received by the model, which may be incomplete. Incomplete data, in this context, may involve some values missing. This node is illustrated as connected to node 210, the missing data indicator, and node 225, the latent variables, suggesting that the observed data may form the basis for inferring latent variables and managing missing information. In some examples, the latent variables may be or include model parameters.

Node 210, the missing data indicator (M), may mark the portions of the observed data that are missing. This node may enable the model to accurately infer the missing values. Node 210 may work in conjunction with node 205, the observed data, and may influence the inference process for node 225, which may represent the latent variables.

Node 215 represents the inducing variables (u). The inducing variables (u) may simplify the model's computations by reducing the number of data records the Gaussian process considers. Node 215 can be influenced by node 225, the latent variables, and can be used by node 220, which may be or include a latent mapping function, such as a multi-layer perceptron, to model uncertainty in the predictions.

Node 220, the latent mapping function (f), may be a component of the Gaussian process and can be responsible for mapping the latent variables to output predictions. Node 220 may use inputs from node 225 (latent variables) and node 215 (the inducing variables) to generate predictions. The predictions can be accompanied by uncertainty estimates, which can be used for assessing reliability of the output.

Node 225 (the latent variables (Z)), may represent hidden factors that influence the observed data and the missing data indicators. The latent variables (Z) may not be directly observed but can be inferred from the observed data. Node 225 can interact with several other nodes such as node 220 (the latent mapping function), node 215 (the inducing variables), node 205 (the observed data), and node 210 (the missing data indicator).

Node 230, representing the theoretical true data values (X*), may denote the theoretical true values of the underlying data, though no direct inference of what the true data values X* are may be made by the model. Instead, the combination of X and M are sufficient replacements for the true data values X* or can otherwise be used to facilitate output of the model.

Node 235, the inducing variable covariance matrix (Σ), may describe the relationships and uncertainty among the inducing points. Node 235 works in conjunction with node 240 (the inducing variable mean parameter) to define the distribution of node 215 (the inducing variables).

Node 240 (the inducing variable mean parameter (μ)), can summarize the key points of the data distribution for the inducing variables. Node 240 may collaborate with node 235 (the inducing variable covariance matrix), to define the distribution of the node 215 (the inducing variables).

Node 245 (the Pólya-Gamma Scaling Factor (ω)), may be utilized during the training process to facilitate scaling and optimization by adjusting the Bayesian estimation algorithm. Node 245 may work with the node 215 (the inducing variables) and the node 250 (the inference adjustment parameters) to enhance the efficiency of the training process.

Node 250, the inference adjustment parameters (c), may fine-tune the model's inference process such as to enhance accuracy and efficiency of the model. The parameters may adjust the behavior of the node 245 (the Pólya-Gamma scaling factor) and may contribute to the training of node 220, the latent mapping function.

Node 255 (the latent variable parameters (φ)), may define how the latent variables are generated and interact within the model. The parameters may influence the behavior of node 225, the latent variables, and can facilitate the functioning of node 220, the latent mapping function.

Node 260, the output (Y) corresponds to the predicted output of the DKL-GP model, which may represent regression results, classification labels, or other forms of predicted outcomes depending on the task. Node 260 may capture the final result after the input data has been processed through the Gaussian process and the latent mapping function. The predicted output Y may be the target variable that the model aims to estimate during the training phase across training data sets. The output Y is used to compare against the true labels or values during training, which can guide the optimization of the model.

Table 1 summarizes non-limiting information about the above-described nodes and related parameters.

TABLE 1
Nodes in the DAG for DKL-GP Architecture

| | | | | Example Relationship |
|---|---|---|---|---|
| Node | Symbol | Shorthand | Example Description | to Other Nodes |
| Node | X | Observed Data | Represents the raw input data | May be connected to the Missing |
| 205 | | | received by the model, which | Data Indicator (Node 210) and Latent |
| | | | may include missing values. | Variables (Node 225). Forms the |
| | | | | basis for inferring latent variables. |
| Node | M | Missing Data | Indicates which portions of | May work alongside Observed Data |
| 210 | | Indicator | the observed data are missing | (Node 205) to manage missing |
| | | | or incomplete. | information. Connected to Latent |
| | | | | Variables (Node 225) for inference. |
| Node | u | Inducing | A synthetic set of input | Derived from the Latent Variables |
| 215 | | Variables | variables used to train the | (Node 225) and used by the Latent |
| | | | Gaussian process, summarizing | Function (Node 220) for uncertainty |
| | | | the data, simplifying the | modeling. |
| | | | model's computations. | |
| Node | f | Latent Mapping | Represents the function learned | May take inputs from the Latent |
| 220 | | Function | by the Gaussian process to map | Variables (Node 225) and Inducing |
| | | | latent variables to output | Variables (Node 215). Generates |
| | | | predictions. | predictions with uncertainty |
| | | | | estimates. |
| Node | Z | Latent | Hidden variables inferred from | May be processed by the Latent |
| 225 | | Variables | the observed data that explain | Mapping Function (Node 220) and |
| | | | underlying structures not | may be influenced by both the |
| | | | directly observed. | Observed Data (Node 205) and |
| | | | | Missing Data Indicator (Node 210). |
| Node | X* | Inferred True | The model's estimation of | May be derived from the Latent |
| 230 | | Data Values | the complete data, including | Mapping Function (Node 220) and |
| | | | imputed values for missing data. | used as the final output of the model. |
| Node | Σ | Inducing | Describes the relationships and | May work in conjunction with the |
| 235 | | Variable | uncertainty among the inducing | Inducing Variable Mean Parameter |
| | | Covariance | variables. | (Node 240) to define the distribution |
| | | Matrix | | of Inducing Variables (Node 215). |
| Node | μ | Inducing | Represents the mean of the | May collaborate with the Inducing |
| 240 | | Variable Mean | inducing variables, efficiently | Variable Covariance Matrix (Node |
| | | Parameter | summarizing the data in key | 235) to define the distribution of |
| | | | points. | Inducing Variables (Node 215). |
| Node | ω | Polya-Gamma | Facilitates scaling and | May work with Inducing Variables |
| 245 | | Scaling Factor | optimization during training by | (Node 215) and Inference |
| | | | adjusting data representation. | Adjustment Parameters (Node 250) |
| | | | | to optimize training. |
| Node | c | Inference | Fine-tunes the model's inference | May adjust the behavior of the Polya- |
| 250 | | Adjustment | process to enhance accuracy and | Gamma Scaling Factor (Node 245) |
| | | Parameters | efficiency. | and contributes to the training of the |
| | | | | Latent Function (Node 220). |
| Node | φ | Latent Variable | Parameters that define how | May influence the behavior of Latent |
| 255 | | Parameters | latent variables are generated | Variables (Node 225) and are |
| | | | and interact within the model. | integral to the functioning of the |
| | | | | Latent Mapping Function (Node 220) |
| Node | Y | Predicted | Represents the final predicted | Node 260 may be influenced by the |
| 260 | | Output | output of the model. | Latent Mapping Function (Node |
| | | | | 220), which maps the latent variables |
| | | | | (Node 225) to the output space. |

c. Example of Machine-Learning Models Used in Conjunction with DKL-GP Architecture

The DKL-GP architecture may be configured to train models that combine the strengths of deep learning and Bayesian statistics For example, the model may be a Deep Kernel Learning model with Gaussian processes. This approach may leverage a deep neural network to learn a representation of the input data, which may then be fed into a Gaussian process to capture uncertainty and make predictions. The model may be configured to perform tasks in which data may be incomplete or noisy and in which quantifying uncertainty is performed.

The DKL-GP framework may be flexible and can integrate various types of models beyond conventional neural networks. The various types of models can serve different roles, such as from feature extraction to direct prediction, depending on the nature of the input data and the specific requirements of the task. As each machine-learning model offers unique strengths, it is possible to tailor the DKL-GP approach to a wide range of applications, such as from image recognition to natural language processing, to handling relational or graph-structured data, or any other suitable application.

In addition to neural networks, the DKL-GP framework may be utilized with various other neural network models depending on the nature of the data and requirements of the task. For instance, convolutional neural networks (CNNs) may be employed for processing image data, while recurrent neural networks (RNNs) or long short-term memory networks (LSTMs) may be used for sequential data such as time series or natural language. Autoencoders may serve as a preprocessing step to reduce data dimensionality, and Random Forests can be integrated in a hybrid approach in which their outputs can be refined by the Gaussian process. Support vector machines (SVMs) may be incorporated for initial classification, with the DKL-GP framework further refining predictions. Furthermore, Bayesian networks can model complex dependencies, while graph neural networks (GNNs) may be used for graph-structured data. Other models, such as Gaussian Mixture Models (GMMs), may assist in clustering tasks, and principal component analysis (PCA) may be used for dimensionality reduction. Transformers, can be integrated to handle text or other sequence-based inputs. The diverse models can complement the DKL-GP framework, making it a versatile tool for a wide range of applications.

d. Example of Interaction of Layers in a Neural Network

In some examples, the DKL-GP model may utilize a pre-trained neural network. The neural network incorporated within the DKL-GP model may include multiple layers, which may each be designed to perform specific functions. For example, DKL-GP can use a pre-trained neural network, such as by first training the neural network and fixing it, then using its input to train the “last layer” Gaussian process, or can engage in joint training of the neural network and Gaussian process simultaneously.

The input layer may be configured to receive raw input data, such as feature vectors representing various attributes of the data points such as entity attributes, sensor readings, etc. The input layer may facilitate the initial processing and transmission of data to subsequent layers for further analysis. The hidden layers, also referred to as feature extraction layers, may be responsible for transforming the input data into a more compact and abstract representation. The hidden layers may include fully connected, or dense, layers, convolutional layers, or other suitable types, depending on the nature of the input data. Activation functions, such as a Rectified Linear Unit (ReLU), may be applied within the hidden layers to introduce non-linearity and enhance the model's ability to capture complex patterns in the data. The hidden layers may iteratively refine the data such as to extract high-level features that may be used for the subsequent stages of the model. The output layer of the neural network may be configured to generate a final representation of the data, which may be suitable for input into the Gaussian process component of the DKL-GP model. The output layer may reduce the dimensionality of the data such as to transform the data into a lower-dimensional embedding space that preserves the essential characteristics of the input data while facilitating efficient processing by the Gaussian process.

The Gaussian process layer may utilize the learned representation from the neural network to model uncertainty and generate predictions. The Gaussian process may employ a kernel function to measure the similarity between data points in the embedding space such as to enable the model to provide predictions with associated uncertainty estimates. This layer may be used for applications in which understanding the confidence of predictions may be involved with incomplete or noisy data.

e. Training of Machine-Learning Model with Respect to the DAG

Turning back to the architecture 200, the training process of the machine-learning model is initiated with the observed data X, which can represent the raw input data collected from various sources. The observed data can be incomplete, meaning that certain values within the dataset may be missing. The missing data may be indicated by the missing data indicator M, which may mark the specific dimensions within the data records where information may be lacking.

The model may employ latent variables Z to capture the hidden or unobserved factors that influence the observed data. The latent variables may be used to understand the underlying structure of the data, as they represent the dimensions within a data record that may not be directly observable but may impact the model's predictions. The latent function f may be responsible for mapping the latent variables Z into the output space of the Gaussian process. The mapping function may allow the model to generate predictions by translating the latent variables into concrete outcomes or decisions, which can help the model predict the target variables even when faced with incomplete data.

To handle the complexity and scale of real-world datasets, the model introduces inducing variables u, which are learned summarization of the input data records that train the Gaussian process (GP). The inducing variables, along with the mean u and covariance 2, can reduce the computational burden associated with GP models. By training the GP using a limited number of inducing variables, as opposed to the full data sample, the model can efficiently process large datasets without compromising accuracy, making it feasible to apply GP-based models to high-dimensional data with many missing values. In some examples, the inducing variables can be selected for the DKL-GP framework based on a clustering algorithm that groups similar data points together.

During the training process, the Pólya-Gamma scaling factor ω and additional inference adjustment parameters c may be utilized to accelerate the optimization of the model parameters. The Pólya-Gamma scaling factor ω may be particularly effective in enhancing the scalability of the model by adjusting the data representation during training. This adjustment can improve the learning efficiency and can ensure that the model can accommodate complex data structures and large volumes of information. The parameters c may provide fine-tuning capabilities, which can allow the model to achieve greater accuracy by refining the inference process.

As the training progresses, the model may account for the missingness of information, which learns the pattern of missingness in X while obviating the need to infer potential values of X*. The model may not make inferences about the potential values of X*. This architecture may be particularly advantageous in scenarios in which data completeness cannot be guaranteed, such as in behavioral modeling, medical diagnostics, or any field where data is prone to missing values or inconsistencies at the individual data record level. By leveraging latent variables, inducing variables, and advanced optimization techniques, the model can maintain high performance and reliability, offering accurate predictions despite the inherent challenges posed by incomplete datasets.

III. Flowchart for Training and Optimizing a DKL-GP Model with Scalability

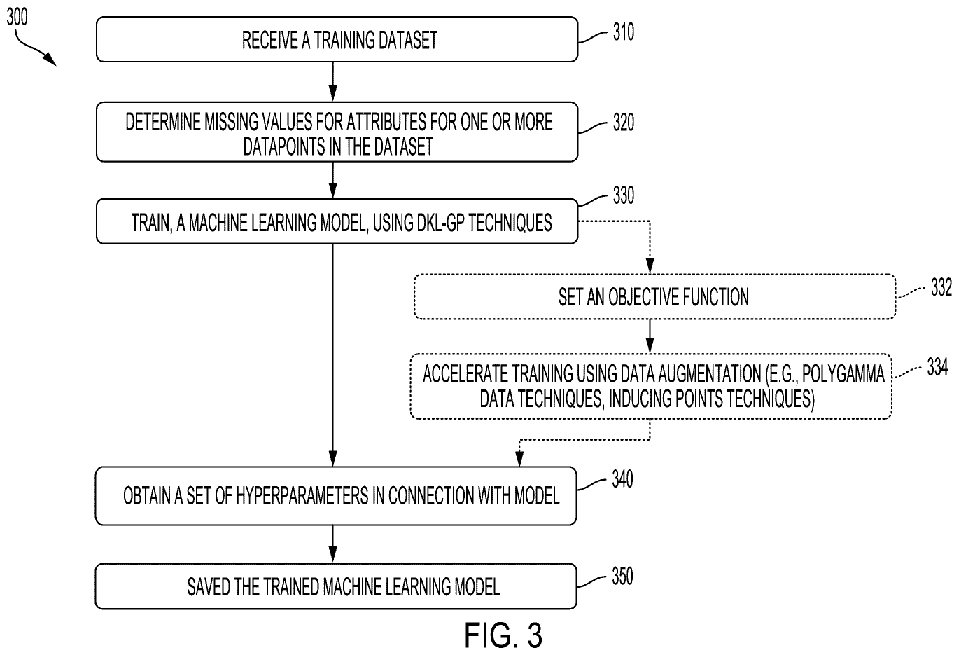

FIG. 3 is a flowchart illustrating an example of a process 300 for training a DKL-GP (Deep Kernel Learning with Gaussian processes) model according to some aspects of the present disclosure. In some examples, the operations of the process 300, or any subset thereof, may be performed by a machine-learning optimization system via a training server, but other suitable systems, devices, or subsets or combinations thereof may perform one or more operations described with respect to the process 300. For illustrative purposes, the process 300 is described with reference to certain examples depicted in the figures. Other implementations, however, are possible.

At block 310, the process 300 involves obtaining a training dataset. The training dataset serves as the foundation for the model's learning. The training dataset can include structured data with rows representing instances of individual records, such as entity interactions, and columns representing attributes such as risk assessments, resource levels or amounts, or transaction histories. The training dataset may be sourced from various databases, which may involve preprocessing to ensure consistency in format and content. Some of the training data may be missing, and this missing data can result from various factors, such as incomplete data entry, privacy restrictions, or gaps in data collection over time.

In some examples, aspects of the training data set may include any of the following attributes. Variables detailing the age distribution of accounts, such as the age of the oldest account, which reflects the maturity and depth of interaction history-a factor traditionally associated with lower risk. The training data may also include balance-related variables, providing insights into current obligations across various account types, including both secured and unsecured agreements, thus illustrating the overall debt burden. The data point can include information on bankruptcies, capturing both current and past bankruptcies as well as nuanced indicators of financial distress, highlighting different stages and impacts on financial standing. Additionally, it may detail charged-off accounts, not just in terms of total amounts but also in terms of recency, frequency, and recovery efforts, offering a multifaceted view of past financial failures. Collections data may be included, extending beyond third-party collections to encompass the types, statuses, and amounts of collection items, thereby offering insights into the severity and nature of debts being pursued.

At block 320, the process 300 involves accounting for the missingness of information. Under Bayesian inference, the model may recognize the existence that there are, in principle, true values. The model may not make inferences about the potential values of X*. Identifying and managing missing data may be useful for maintaining the integrity of the training process. In some examples, the techniques described above with respect to FIG. 2 may be used to determine the effect of having certain missing values without imputing what those values may be. Referring back to FIG. 2, the determination of missing values from the dataset may include the data included in node 210, marked with the symbol M.

At block 330, the process 300 involves training a machine-learning model using a DKL-GP technique or DKL-GP model. For example, the machine-learning model may be trained iteratively, using a subset of the training dataset, by a DKL-GP model. The model may iteratively process subsets of the data to adjust its parameters. Each iteration refines the model's predictions, allowing the model to better capture the underlying patterns in the data. The model may use batch processing to handle large datasets, improving efficiency by breaking the data into manageable chunks. Over multiple iterations, the model may become increasingly accurate in its predictions, learning the relationships between different data attributes.

At block 330, any training process may be used. This may include and is not limited to the graphical representation provided above with respect to FIG. 2. At block 332, the process 300 involves setting the objective function. Setting the objective function may be used for guiding the model's learning. The objective function may combine a loss function, which measures the difference between the predicted and actual values, with a regularization term that prevents the model from overfitting. The function may serve as the model's target during training, ensuring that each iteration brings the model closer to optimal performance. Using the objective function may overcome at least two drawbacks to the straightforward estimation of the DKL-GP: (1) the cubic O(n³) computational complexity of GPs entails that application to the credit file data is infeasible, and (2) the non-conjugacy of relevant equations may entail a lack of a tractable posterior predictive distribution.

The objective function may be set to overcome these, and other limitatins. The inference of the model may involve computing the target joint posterior, while taking advantage of the conditional conjugacy gained via PG data augmentation, the scalability of the inducing points, and the mapping of (X, [symbol] ) to continuous embeddings in [symbol] via DKL. This may be accomplished via SVI by marginalizing over the latent variables ω and u, and optimizing the DKL neural network parameters θ, as well as variational parameters. Variational inference can involve a potential for scalability in empirical applications, in terms of both computing time and resources, in which posterior inference can be achieved. Variational inference may transform the high-dimensional integration problem of posterior inference into a tractable optimization problem, via a principled framework to minimize the Kullbeck-Leibler (KL) divergence between the posterior density, such as in Equation 1, and an approximating variational density q(u,ω) on the latent variables, which is otherwise equivalent to optimizing the evidence lower bound (ELBO) on the marginal likelihood.

$$p ( f \vert y , ω , u , z ) ∝ exp ( \frac{1}{2} {y}^{T} f - \frac{1}{2} {f}^{T} Ω f ) p ( ω ) p ( f \vert u ) p ( u ) \qquad ( 1 )$$

The choice of the approximating distribution q(θ) can be used to formulate variational objective functions, impacting the degree to which KL divergence can be in-principle minimized, the accuracy of the estimates, and the scalability at runtime. Variational approximation can involve the complete data likelihood being unaltered, but rather augmented with “approximating” densities to jointly form a single optimization bound. As part of the variational objective may be the parameters {θ,μ,Σ,c}, which may be optimized, corresponding those of the DKL hyperparameters, as well as distributional parameters of q(u) and q(ω), respectively.

At block 334, the process 300 may include accelerating the DKL-GP training by using the Pólya-Gamma data augmentation technique and inducing points. To enhance the training process, Pólya-Gamma data and inducing points may be employed. These techniques may address the challenges of scaling the training process to large datasets. The Pólya-Gamma data augmentation may facilitate faster computations by focusing on the most significant aspects of the data, while inducing points may reduce the dimensionality of the problem, simplifying the model and making the training process more efficient. In some examples, the Pólya-Gamma data augmentation may operate on the individual data points while the inducting points may be acting on the ‘columns’ of the data. By reducing the computational load, these techniques may make it feasible to train the DKL-GP model on datasets that would otherwise be too large or complex to handle in a realistic time period.

At block 340, the process 300 may include obtaining a set of hyperparameters for the trained machine-learning model or for the DKL-GP model. Hyperparameters may define the model's architecture and may guide the training process. The system may use optimization techniques to find the best hyperparameters, such as the learning rate or the number of inducing points, that result in the highest model performance. The selection of hyperparameters is a balance between accuracy and computational efficiency, ensuring the model is both powerful and practical for real-world applications.

At block 350, the process 300 may include saving the trained machine-learning model for further use. Once the model is fully trained, the model can be saved for deployment in practical applications. The trained model can be used to make predictions on new data, providing valuable insights or automating decision-making processes. For example, the model may be used to assess the creditworthiness of loan applicants, providing real-time risk assessments based on the applicant's data. The model is saved along with its hyperparameters and training history, allowing for future updates or audits.

IV. Flowchart for Using Trained ML Model from DKL-GP Framework

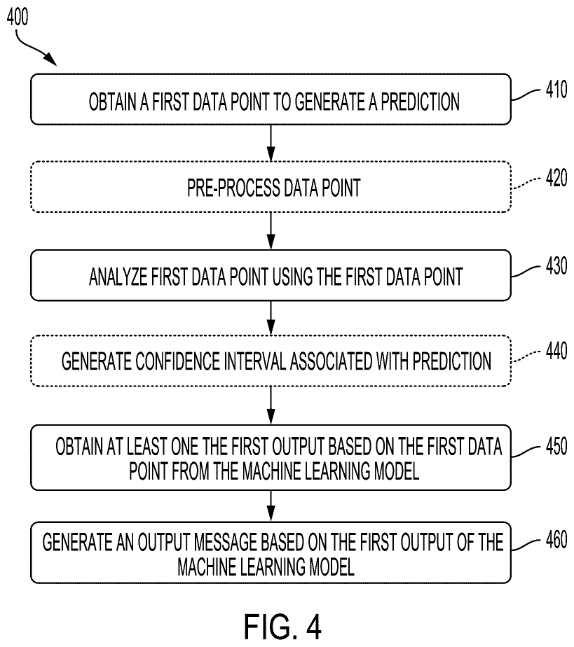

FIG. 4 is a flowchart illustrating an example of a process 400 for making a decision using a trained machine-learning model according to some aspects of the present disclosure. In some examples, the operations of the process 400, or any subset thereof, may be performed by a decision-making system via an assessment server, but other suitable systems, devices, or subsets or combinations thereof may perform one or more operations described with respect to the process 400. For illustrative purposes, the process 400 is described with reference to certain examples depicted in the figures. Other implementations, however, are possible.

At block 410, the process 400 may include obtaining a first data record. This record may be related to an individual's financial history, such as credit score, income, or previous loan repayments. The data point can be obtained from various sources, including credit bureaus, bank records, or user-provided information during a credit application process. In some examples, the data point may also include derived or inferred attributes, such as spending behavior patterns or credit utilization rates.

At block 420, the process 400 may include preprocessing the data point. Preprocessing the data point may be performed to ensure the accuracy and reliability of the machine-learning model's output. This may involve tasks such as normalizing numerical values to a common scale, encoding categorical variables into numerical formats, and handling missing data points using techniques like imputation or, in some cases, Deep Kernel Learning (DKL) for inferring missing values. Additionally or alternatively, preprocessing may include detecting or correcting anomalies or outliers in the data that could skew the model's predictions. Data transformation and feature engineering may also be performed at this stage to create new variables that better capture the underlying behaviors of the individual.

At block 430, the process 400 may include analyzing the first data record using the trained machine-learning model. The trained machine-learning model, which may incorporate advanced techniques such as DKL-GP, can process the preprocessed data to predict an outcome related to the individual's creditworthiness. The analysis may involve complex computations in which the model assesses various risk factors, taking into account the potential interactions between different data attributes. The model may also account for uncertainty in the predictions by estimating how much influence the set of missing attributes for a data record have on the final outcome, without inferring the potential values of those attributes. The analysis can include generating multiple predictive outputs, each reflecting different aspects of the individual's behavior.

At block 440, the process 400 may include generating a confidence interval. The confidence interval can provide an estimate of the uncertainty associated with the model's prediction, giving further insight into the reliability of the output. This interval may be predicted in examples in which the decision involves high stakes such as approving large loans or extending credit to individuals with limited credit history. The confidence interval can help in setting thresholds for automatic approvals or denials, or in flagging cases that require manual review by officers. It may also guide the institution in determining appropriate parameters.

At block 450, the process 400 may include obtaining at least the first output from the trained machine-learning model. The model can produce an output, such as a predicted credit score, a risk rating, or another relevant metric, that reflects the individual's likelihood of repaying a loan or managing credit responsibly. The output may be a composite score derived from multiple factors, including the individual's income stability, debt-to-income ratio, and historical payment behaviors. In some implementations, the output might be accompanied by explanatory features or decision rules that provide transparency into how the prediction was made.

At block 460, the process 400 may include generating an output message based on at least the first output from the trained machine-learning model. The output message may be configured to cause control of one or more computing systems. The output control message may include information that can be used to control a computing system, access a computing system, or cause a computing system to perform a certain action. For example, in the context of an autonomous vehicle, an output message can indicate that a certain action should or should not be taken based on the content of the output message such as high confidence values regarding the relative position of the vehicle, low confidence of the position of the vehicle, etc. In some examples, by using the output of the machine-learning model, a credit related decision may be made. Based on the model's output and possibly other rules, the system may decide to approve, deny, or flag the credit application for further review. The decision may be automated, with the system applying predefined thresholds to the model's output, or the decision may be part of a more complex decision-making framework that includes oversight. The system may generate recommendations for additional actions, such as offering alternative credit products or suggesting a lower loan amount. The final decision may be communicated back to the applicant along with an explanation of the factors that influenced the decision.

### V. Example Empirical Results

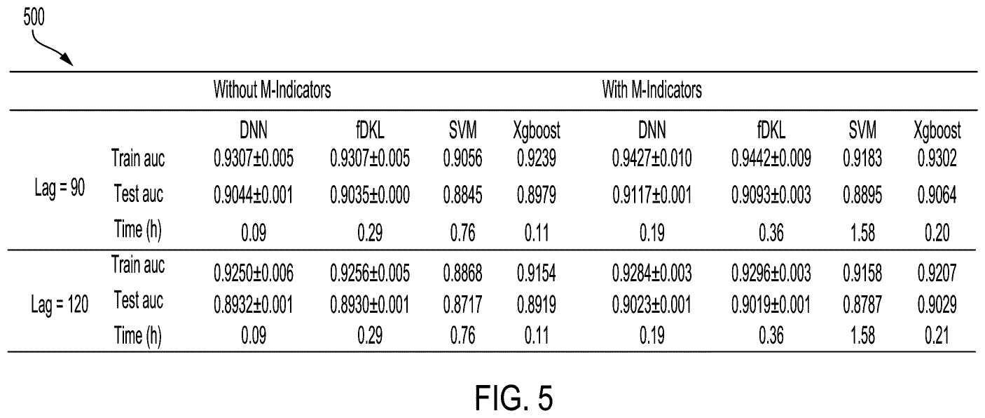

FIG. 5 illustrates table 500, which illustrates some advantages of the system and techniques described herein. In one aspect of the system, the performance of the Deep Kernel Learning with Gaussian processes (DKL-GP) model is benchmarked against a range of established models, including linear binary logistic models, non-linear models such as neural networks and boosted trees, as well as nested variants of the DKL-GP model. The benchmarks, as illustrated in the relevant figures, demonstrate the superior performance of the DKL-GP model. The DKL-GP model consistently outperforms other machine-learning models, with a marked improvement in out-of-sample goodness-of-fit. This enhanced performance can be attributed in part to the inclusion of missing data indicators, which significantly contribute to the model's ability to generalize effectively.

### VI. Example of Computing System

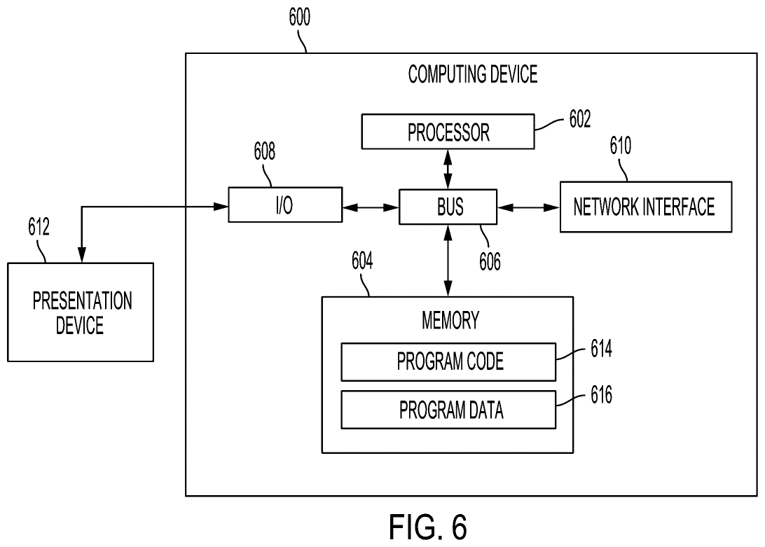

Any suitable computing system or group of computing systems can be used to perform the operations for the techniques described herein. For example, FIG. 6 is a block diagram depicting an example of a computing device 600, which can be used to implement the systems described herein. The computing device 600 can include various devices for communicating with other devices in the computing environment 100, as described with respect to FIG. 1. The computing device 600 can include various devices for performing one or more operations, such as those described above with respect to FIGS. 1-5.

The computing device 600 can include a processor 602 that can be communicatively coupled to a memory 604. The processor 602 can execute computer-executable program code stored in the memory 604, can access information stored in the memory 604, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc., may be passed, forwarded, or transmitted via any suitable means including memory sharing, message passing, token passing, network transmission, among others.

Examples of a processor 602 can include a microprocessor, an application-specific integrated circuit (ASIC), a field-programmable gate array (FPGA), or any other suitable processing device. The processor 602 can include any suitable number of processing devices, including one. The processor 602 can include or communicate with a memory 604. The memory 604 can store program code that, when executed by the processor 602, causes the processor 602 to perform the operations described herein.

The memory 604 can include any suitable non-transitory computer-readable medium. The computer-readable medium can include any electronic, optical, magnetic, or other storage device capable of providing a processor with computer-readable program code or other program code. Non-limiting examples of a computer-readable medium can include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language can include Hadoop, C, C++, C #, Visual Basic, Java, Python, Perl, JavaScript, ActionScript, etc.

The computing device 600 may also include a number of external or internal devices such as input or output devices. For example, the computing device 600 is illustrated with an input/output interface 608 that can receive input from input devices or provide output to output devices. A bus 606 can also be included in the computing device 600. The bus 606 can communicatively couple one or more components of the computing device 600.

The computing device 600 can execute program code 614 that can include the machine-learning models. The program code 614 may be resident in any suitable computer-readable medium and may be executed on any suitable processing device. For example, and as illustrated in FIG. 6, the program code 614 can reside in the memory 604 at the computing device 400 along with the program data 616 associated with the program code 614. Executing the machine-learning model can configure the processor 602 to perform at least a portion of the operations described herein.

In some aspects, the computing device 600 can include one or more output devices. One example of an output device can be or include the network interface device 610 illustrated in FIG. 6. A network interface device 610 can include any device or group of devices suitable for establishing a wired or wireless data connection to one or more data networks described herein. Non-limiting examples of the network interface device 610 can include an Ethernet network adapter, a modem, etc.

Another example of an output device can include the presentation device 612 depicted in FIG. 6. A presentation device 612 can include any device or group of devices suitable for providing visual, auditory, or other suitable sensory output. Non-limiting examples of the presentation device 612 can include a touchscreen, a monitor, a speaker, a separate mobile computing device, etc. In some aspects, the presentation device 612 can include a remote client-computing device that communicates with the computing device 600 using one or more data networks described herein. In other aspects, the presentation device 612 can be omitted.

In some aspects, systems, methods, and non-transitory computer-readable mediums for deep kernel learning for risk modeling high dimensional missingness are provided according to one or more of the following examples:

As used below, any reference to a series of examples is to be understood as a reference to each of those examples disjunctively (e.g., “Examples 1-4” is to be understood as “Examples 1, 2, 3, or 4”).

Example 1 is a method comprising: receiving a dataset comprising a plurality of data records, wherein at least one data dimension of the plurality of data records indicates a missing value; identifying the missing value within the dataset using a missing data indicator; processing the dataset by applying a deep kernel learning with Gaussian processes (DKL-GP) framework; learning a set of embeddings representing a particular pattern of missing values to facilitate an output prediction generated by applying the DKL-GP framework to the dataset; adjusting an objective function of a machine-learning model within the DKL-GP framework by optimizing model parameters in a training process to generate a trained machine-learning model; and saving the trained machine-learning model for subsequent use in making predictions.

Example 2 is the method of any of the preceding or subsequent examples, further comprising generating a latent variable representing one or more hidden factors influencing the dataset and the missing value.

Example 3 is the method of any of the preceding or subsequent examples, further comprising utilizing a set of inducing variables to approximate a Gaussian process, wherein the set of inducing variables optimizes computational complexity.

Example 4 is the method of any of the preceding or subsequent examples, further comprising mapping the latent variable to the output prediction by using a latent mapping function, wherein the latent mapping function is configured to generate predictions with associated uncertainty estimates.

Example 5 is the method of any of the preceding or subsequent examples, wherein the training process further comprises optimizing the model parameters through stochastic variational inference.

Example 6 is the method of any of the preceding or subsequent examples, further comprising generating a confidence interval for the output prediction, wherein the confidence interval is used to determine a reliability of the output prediction.

Example 7 is the method of any of the preceding or subsequent examples, wherein the training process comprises using a cross-validation technique to evaluate a performance metric of the machine-learning model on different subsets of the dataset.

Example 8 is the method of any of the preceding or subsequent examples, further comprising preprocessing the dataset by normalizing the data points and encoding categorical variables into numerical formats.

Example 9 is the method of any of the preceding or subsequent examples, wherein the DKL-GP framework is implemented using a neural network with a plurality of hidden layers.

Example 10 is the method of any of the preceding or subsequent examples, wherein a Pólya-Gamma scaling factor is applied iteratively during the training process to adjust a learning rate of the machine-learning model.

Example 11 is the method of any of the preceding or subsequent examples, wherein a plurality of inducing variables for the DKL-GP framework are selected based on a clustering algorithm that groups similar data points together.

Example 12 is the method of any of the preceding or subsequent examples, wherein learning the set of embeddings is performed without directly inferring any theoretical values of the missing value.

Example 13 is a method comprising: obtaining a first data record that includes a data dimension that indicates a missing data value; analyzing the first data point using a trained machine-learning model, the model trained using a Deep Kernel Learning with Gaussian processes (DKL-GP) framework; generating at least one output prediction based on analyzing the first data point, wherein the output prediction comprises an uncertainty estimate; and making a decision based on the output prediction and the uncertainty estimate.

Example 14 is the method of any of the preceding or subsequent examples, wherein the trained machine-learning model comprises a neural network, and wherein a latent mapping function is implemented using a multi-layer perceptron.

Example 15 is the method of any of the preceding or subsequent examples, further comprising generating a confidence interval for the output prediction, wherein the confidence interval is used to determine a reliability of the decision.

Example 16 is the method of any of the preceding or subsequent examples, wherein the output prediction is used to suggest a remedial action based on the output.

Example 17 is the method of any of the preceding or subsequent examples, wherein the trained machine-learning model is deployed in a cloud computing environment to enable real-time predictions and model updates based on new incoming data.

Example 18 is the method of any of the preceding or subsequent examples, wherein the trained machine-learning model is further configured to handle sequential data comprising time-series data.

Example 19 is the method of any of the preceding or subsequent examples, wherein the trained machine-learning mode is trained by learning a set of embeddings representing a particular pattern of missing values to facilitate an output prediction generated by applying the DKL-GP framework to the dataset.

Example 20 is the method of any of the preceding or subsequent examples, wherein the trained machine-learning model uses an ensemble of machine-learning models.

Example 21 is the method of any of the preceding or subsequent examples, wherein the uncertainty estimate associated with the output prediction is used to determine a confidence score for the predicted output.

Example 22 is a system comprising: a processor; and a non-transitory computer-readable medium comprising instructions executable by the processor to perform operations comprising: receiving a dataset comprising a plurality of data records, wherein at least one data dimension of the plurality of data records indicates a missing value; identifying the missing value within the dataset using a missing data indicator; processing the dataset by applying a deep kernel learning with Gaussian processes (DKL-GP) framework; learning a set of embeddings representing a particular pattern of missing values to facilitate an output prediction generated by applying the DKL-GP framework to the dataset; adjusting an objective function of a machine-learning model within the DKL-GP framework by optimizing model parameters in a training process to generate a trained machine-learning model; and saving the trained machine-learning model for subsequent use in making predictions.

Example 23 is the system of any of the preceding or subsequent examples, wherein the operations further comprise: (i) generating a latent variable representing one or more hidden factors influencing the dataset and the missing value and (ii) utilizing a set of inducing variables to approximate a Gaussian process, wherein the set of inducing variables optimizes computational complexity.

Example 24 is the system of any of the preceding or subsequent examples, wherein the operations further comprise mapping the latent variable to the output prediction by using a latent mapping function, wherein the latent mapping function is configured to generate predictions with associated uncertainty estimates.

Example 25 is the system of any of the preceding or subsequent examples, wherein the training process further comprises optimizing the model parameters through stochastic variational inference, and wherein the training process comprises using a cross-validation technique to evaluate a performance metric of the machine-learning model on different subsets of the dataset.

Example 26 is the system of any of the preceding or subsequent examples, wherein the operations further comprise generating a confidence interval for the output prediction, wherein the confidence interval is used to determine a reliability of the output prediction.

Example 27 is the system of any of the preceding or subsequent examples, wherein the operations further comprise preprocessing the dataset by normalizing the data points and encoding categorical variables into numerical formats, and wherein the DKL-GP framework is implemented using a neural network with a plurality of hidden layers.

Example 28 is the system of any of the preceding or subsequent examples, wherein a Pólya-Gamma scaling factor is applied iteratively during the training process to adjust a learning rate of the machine-learning model.

Example 29 is the system of any of the preceding or subsequent examples, wherein a plurality of inducing variables for the DKL-GP framework are selected based on a clustering algorithm that groups similar data points together, and wherein the operations further comprise generating synthetic data points to augment the dataset during training.

Example 30 is a non-transitory computer-readable medium comprising instructions executable by a processor to cause the processor to perform operations comprising: obtaining a first data record that includes a data dimension that indicates a missing data value; analyzing the first data point using a trained machine-learning model, the model trained using a Deep Kernel Learning with Gaussian processes (DKL-GP) framework; generating at least one output prediction based on analyzing the first data point, wherein the output prediction comprises an uncertainty estimate; and making a decision based on the output prediction and the uncertainty estimate.

Example 31 is the non-transitory computer-readable medium of any of the preceding or subsequent examples, wherein the trained machine-learning model comprises a neural network, and wherein a latent mapping function is implemented using a multi-layer perceptron.

Example 32 is the non-transitory computer-readable medium of any of the preceding or subsequent examples, wherein the operations further comprise generating a confidence interval for the output prediction, wherein the confidence interval is used to determine a reliability of the decision, and wherein the output prediction is usable to suggest a remedial action based on the output or the inferred missing data values.

Example 33 is the non-transitory computer-readable medium of any of the preceding or subsequent examples, wherein the trained machine-learning model is deployed in a cloud computing environment to enable real-time predictions and model updates based on new incoming data, and wherein the trained machine-learning model is further configured to handle sequential data comprising time-series data.

Example 34 is the non-transitory computer-readable medium of any of the preceding or subsequent examples, wherein the trained machine-learning mode is trained by learning a set of embeddings representing a particular pattern of missing values to facilitate an output prediction generated by applying the DKL-GP framework to the dataset.

Example 35 is the non-transitory computer-readable medium of any of the preceding or subsequent examples, wherein the uncertainty estimate associated with the output prediction is used to determine a confidence score for the predicted output.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

What is claimed is:

1. A method comprising:
receiving a dataset comprising a plurality of data records, wherein at least one data dimension of the plurality of data records indicates a missing value;
identifying the missing value within the dataset using a missing data indicator;
processing the dataset by applying a deep kernel learning with Gaussian processes (DKL-GP) framework;
learning a set of embeddings representing a particular pattern of missing values to facilitate an output prediction generated by applying the DKL-GP framework to the dataset;
adjusting an objective function of a machine-learning model within the DKL-GP framework by optimizing model parameters in a training process to generate a trained machine-learning model; and
saving the trained machine-learning model for subsequent use in making predictions.

2. The method of claim 1, further comprising:
generating a latent variable representing one or more hidden factors influencing the dataset and the missing value;
utilizing a set of inducing variables to approximate a Gaussian process, wherein the set of inducing variables optimizes computational complexity; and
mapping the latent variable to the output prediction by using a latent mapping function, wherein the latent mapping function is configured to generate predictions with associated uncertainty estimates.

3. The method of claim 1, wherein the training process further comprises optimizing the model parameters through stochastic variational inference.

4. The method of claim 1, further comprising generating a confidence interval for the output prediction, wherein the confidence interval is used to determine a reliability of the output prediction.

5. The method of claim 1, wherein the training process comprises using a cross-validation technique to evaluate a performance metric of the machine-learning model on different subsets of the dataset.

6. The method of claim 1, further comprising preprocessing the dataset by normalizing the data points and encoding categorical variables into numerical formats, wherein the DKL-GP framework is implemented using a neural network with a plurality of hidden layers.

7. The method of claim 1, wherein a Pólya-Gamma scaling factor is applied iteratively during the training process to adjust a learning rate of the machine-learning model, and wherein a plurality of inducing variables for the DKL-GP framework are selected based on a clustering algorithm that groups similar data points together.

8. The method of claim 1, wherein learning the set of embeddings is performed without directly inferring any theoretical values of the missing value.

9. A system comprising:
a processor; and
a non-transitory computer-readable medium comprising instructions executable by the processor to perform operations comprising:
receiving a dataset comprising a plurality of data records, wherein at least one data dimension of the plurality of data records indicates a missing value;
identifying the missing value within the dataset using a missing data indicator;
processing the dataset by applying a deep kernel learning with Gaussian processes (DKL-GP) framework;
learning a set of embeddings representing a particular pattern of missing values to facilitate an output prediction generated by applying the DKL-GP framework to the dataset;
adjusting an objective function of a machine-learning model within the DKL-GP framework by optimizing model parameters in a training process to generate a trained machine-learning model; and
saving the trained machine-learning model for subsequent use in making predictions.

10. The system of claim 9, wherein the operations further comprise: (i) generating a latent variable representing one or more hidden factors influencing the dataset and the missing value and (ii) utilizing a set of inducing variables to approximate a Gaussian process, wherein the set of inducing variables optimizes computational complexity.

11. The system of claim 10, wherein the operations further comprise mapping the latent variable to the output prediction by using a latent mapping function, wherein the latent mapping function is configured to generate predictions with associated uncertainty estimates.

12. The system of claim 9, wherein the training process further comprises optimizing the model parameters through stochastic variational inference, and wherein the training process comprises using a cross-validation technique to evaluate a performance metric of the machine-learning model on different subsets of the dataset.

13. The system of claim 9, wherein the operations further comprise:
generating a confidence interval for the output prediction, wherein the confidence interval is used to determine a reliability of the output prediction; and
preprocessing the dataset by normalizing the data points and encoding categorical variables into numerical formats, and wherein the DKL-GP framework is implemented using a neural network with a plurality of hidden layers.

14. The system of claim 9, wherein a Pólya-Gamma scaling factor is applied iteratively during the training process to adjust a learning rate of the machine-learning model.

15. The system of claim 9, wherein a plurality of inducing variables for the DKL-GP framework are selected based on a clustering algorithm that groups similar data points together, and wherein the operations further comprise generating synthetic data points to augment the dataset during training.

16. A non-transitory computer-readable medium comprising instructions executable by a processor to cause the processor to perform operations comprising:
receiving a dataset comprising a plurality of data records, wherein at least one data dimension of the plurality of data records indicates a missing value;
identifying the missing value within the dataset using a missing data indicator;
processing the dataset by applying a deep kernel learning with Gaussian processes (DKL-GP) framework;
learning a set of embeddings representing a particular pattern of missing values to facilitate an output prediction generated by applying the DKL-GP framework to the dataset;
adjusting an objective function of a machine-learning model within the DKL-GP framework by optimizing model parameters in a training process to generate a trained machine-learning model; and
saving the trained machine-learning model for subsequent use in making predictions.

17. The non-transitory computer-readable medium of claim 16, wherein the operations further comprise: (i) generating a latent variable representing one or more hidden factors influencing the dataset and the missing value and (ii) utilizing a set of inducing variables to approximate a Gaussian process, wherein the set of inducing variables optimizes computational complexity.

18. The non-transitory computer-readable medium of claim 17, wherein the operations further comprise mapping the latent variable to the output prediction by using a latent mapping function, wherein the latent mapping function is configured to generate predictions with associated uncertainty estimates.

19. The non-transitory computer-readable medium of claim 16, wherein the training process further comprises optimizing the model parameters through stochastic variational inference, and wherein the training process comprises using a cross-validation technique to evaluate a performance metric of the machine-learning model on different subsets of the dataset.

20. The non-transitory computer-readable medium of claim 16, wherein the operations further comprise:
generating a confidence interval for the output prediction, wherein the confidence interval is used to determine a reliability of the output prediction; and
preprocessing the dataset by normalizing the data points and encoding categorical variables into numerical formats, and wherein the DKL-GP framework is implemented using a neural network with a plurality of hidden layers.
